(19) United States
(12) Patent Application Publication
(10) Pub. No.: US 2004/0247324 A1
(43) Pub. Date: Dec. 9, 2004

(54) Filtered three-level transmitter

(76) Inventor: Jason B. Stark, Holmdel, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/775,053

(22) Filed: Feb. 9, 2004

Related U.S. Application Data
(60) Provisional application No. 60/445,745, filed on Feb. 7, 2003.

(51) Int. Cl. H04B 10/04

(52) U.S. Cl. 398/182

(57) ABSTRACT

A filtered three-level transmitter is provided by filtering a binary electrical drive signal to produce a unit modulation pulse spanning four-bit-periods and describable by three parameters. One or more of the three parameters of the unit modulation pulse are adjusted to optimize a figure of merit associated with performance of an optical transmission system. A three-level electrical drive signal is then generated from the unit modulation pulse for input to a Mach-Zehnder modulator. The three parameters of the unit modulation pulse are each defined over a half-bit period and together are sufficient to describe a line-coded transmission eye diagram. The parameters are adjusted so that an optical transmission system in which the inventive transmitter is utilized is optimized with a set level of net chromatic dispersion.

### STATEMENT OF RELATED APPLICATION

This application claims the benefit of priority to U.S. Provisional Patent Application Serial No. 60/445,745, filed Feb. 7, 2003 and entitled “Filtered Three-Level Transmitter.”

### FIELD OF THE INVENTION

This invention relates generally to optical communications, and more particularly to a filtered three-level transmitter.

### BACKGROUND OF THE INVENTION

Dispersive propagation of signals in optical fiber represents an important impairment mechanism in optical communications. Signals propagating through optical fiber experience pulse distortion due to chromatic dispersion. This distortion is manifest as a broadening of the transitions between symbols transmitted through the fiber. At sufficiently high levels of dispersion, inter-symbol interference (“ISI”) occurs where the symbols measured at the receiver at one time are influenced by the presence of symbols at other times. This effect can increase the error rate of transmission and diminish performance.

Optical fiber communications systems have traditionally used on-off keying (“OOK”) as the line code of choice, preferred for its simplicity of implementation. This binary line code transmits a pulse of unit amplitude to indicate a mark, and the absence of a pulse to indicate a space. At the receiver, the signal is measured by a photodetector. This method, called intensity modulation-direct detection (“IM-DD”), offers the simplest means of establishing a transmission link using optical fiber. The optical signals launched using OOK IM-DD can be generated in a Mach-Zehnder (“MZ”) modulator. The MZ modulator impresses an amplitude and phase modulation onto incident continuous-wave (“CW”) light

It is thus an object of the present invention to reduce the penalties associated with dispersive optical propagation.

### SUMMARY OF THE INVENTION

A filtered three-level transmitter is provided by filtering a binary electrical drive signal to produce a unit modulation pulse spanning four-bit-periods and describable by three parameters. One or more of the three parameters of the unit modulation pulse are adjusted to optimize a figure of merit associated with performance of an optical transmission system. A three-level electrical drive signal is then generated from the unit modulation pulse for input to a Mach-Zehnder modulator. The three parameters of the unit modulation pulse are each defined over a half-bit period and together are sufficient to describe a line-coded transmission eye diagram. The parameters are adjusted so that an optical transmission system in which the inventive transmitter is utilized is optimized with a set level of net chromatic dispersion to thereby reduce the dispersive optical propagation penalty.

In an illustrative embodiment of the invention, an inventive transmitter utilizes a filter for filtering a received binary electrical drive signal to produce a transmission having a unit modulation pulse with substantially three levels. A modulator is coupled to the filter so that the unit pulse produces optimized transmission performance over a set of values of net chromatic dispersion.

### BRIEF DESCRIPTION OF THE DRAWINGS

FIG. 1 is a simplified depiction of a finite space machine with alternate space inversion line coding;

FIG. 2 shows a sample eye diagram that illustrates the three-level aspect of an electrical drive signal and the inter-symbol interference that results from filtering, in accordance with the invention.:

FIG. 3 shows a sample eye diagram that illustrates the association between eye traces and unit modulation pulse components, in accordance with the invention;

FIG. 4 depicts a unit modulation pulse for a novel four-period three-parameter coding scheme, in accordance with the invention;

FIG. 5 shows an illustrative unit pulse, in accordance with the invention;

FIG. 6 is shows sample dispersion performance for optimized line codes, in accordance with the invention; and

FIG. 7 shows an illustrative arrangement which facilitates practice of the inventive filtered three-level transmitter.

### DETAILED DESCRIPTION

A generalized transmitter may be represented as an input data stream, followed by a line coder, and a modulator that produces an output data stream. In this case, the input data stream, aₖ, is taken from the binary input alphabet, A={0,1}. For each instance of input symbol, a, in the sequence, {aₖ},

a=αᵢ∈A (1)

for some i. This input data stream is processed by the line code to produce an output sequence, {bₖ}, where each instance of output symbol, b, is taken from output alphabet, B.

The output alphabet shall be binary, B={0,1}. For each instance of output symbol, b, in the sequence, {bₖ},

b=βⱼ∈B, (2)

for some j. The line code, L, connects output to input, according to

{bₖ}=L({aₖ}), (3)

where {aₖ} and {bₖ} are the input and output sequences, respectively. There is exactly one output symbol for each input bit. At the receiver, one bit of information will be determined from each transmitted symbol, making the line codes considered here unity-rate.

A broad class of line codes is described by the evolution of a finite state machine (“FSM”). For each state in the FSM, each input symbol will cause a transition to another state of the FSM. Upon each transition, an output symbol is produced. In this way, the input symbol sequence produces transitions in the FSM, as an output sequence is generated. In general, the output symbol will depend not just on the input symbol, but on the entire prior history of the input sequence. Explicitly,

bₙ=L({aₖ,k≦n}). (4)

The associated transition matrix, coupling initial states and input symbols to final states and output symbols, entirely defines the FSM, and the associated line code.

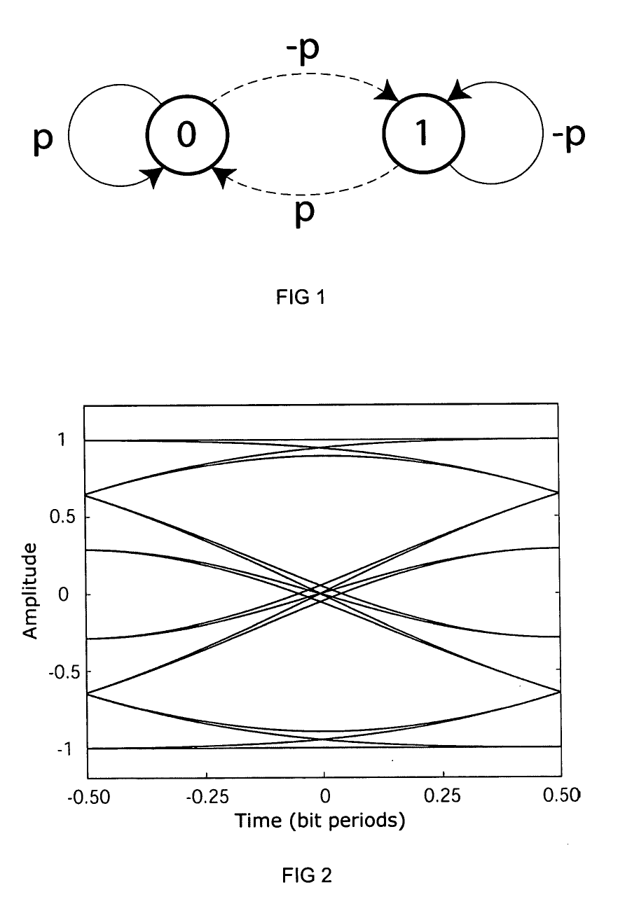

An exemplary alternate-space-inversion (“ASI”) FSM is depicted in FIG. 1. There, as shown, beginning in state 0, an input 0 causes transition to state 1 with emission of output pulse −p; input 1 causes transition back to state 0, emission of output pulse p. Beginning in state 1, an input 0 causes transition to state 0 with emission of output pulse p; input 1 causes transition back to state 1, emission of output pulse −p

The encoded output is generated by applying the amplitudes, {bₖ}, to a unit modulation pulse, p(t), so that

$$V ( t ) = {\sum }_{k} {b}_{k} p ( t - k {T}_{0} ) \qquad ( 5 )$$

where T₀ is the clock period. The unit modulation pulse is produced by filtering the output of an electronic drive circuit using an optimized filter. In accordance with the principles of the invention, by designing the filter to produce an optimized modulation pulse shape, significant benefits are obtained under dispersive propagation.

The resulting signal is applied to an optical modulator, where the electrical signal is converted to an optical transmission. The voltage signal, V(t), is applied to a Mach-Zehnder optical modulator, so that the optical field envelope output is

$${e}_{Tx} ( t ) = {E}_{0} sin ( \frac{π}{2} \cdot V ( t ) ) , \qquad ( 6 )$$

where E₀ is the field amplitude.

It is important in the construction of the inventive dispersion tolerant line codes to maintain a set of constraints for consistency with existing transmission practices. The first constraint is that the signal be receivable using a standard IM-DD single-threshold discriminating receiver. Observation of this constraint provides transmissions that are consistent with currently deployed receivers. The second constraint is that the codes use the ASI FSM for coding modulation amplitudes.

The use of the ASI FSM allows a set of line codes (referred to here as “ASI Codes”), to be defined by specifying the unit modulation pulse. It is desirable to describe this space of important modulation functions using as few parameters as possible. Accordingly, a novel class of four-bit-period, three-parameter (“4P3P”) unit modulation pulses is formulated. In accordance with the invention, these unit pulses may be produced by filtering the output of a standard binary electrical drive circuit. The choice of four bit periods is motivated by the observation that, typically, ISI produces at most 16 separate traces in the transmission eye diagram. A sample transmission eye diagram is shown in FIG. 2 which illustrates the three-level aspect of the electrical drive signal, together with the ISI, that results from filtering. As shown, at any instant, there are 16 different values to the field, corresponding to the four unit pulses that contribute through ISI.

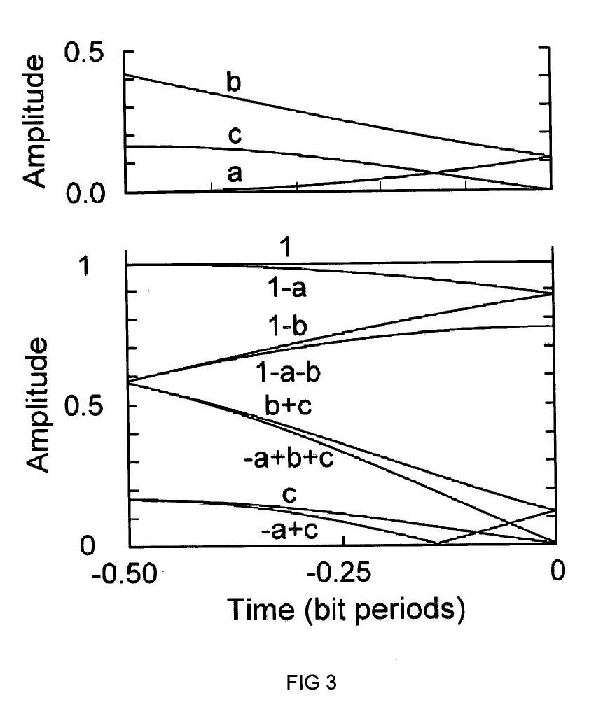

A first step toward constructing the class of 4P3P modulation pulses is to note that there is structure inherent within the eye diagrams of line coded transmissions. As shown in the upper left quadrant of the modulator drive eye diagram, FIG. 3, the set of traces can be related to each other by identifying three functions, a, b and c. These functions are depicted in the inset portion of FIG. 3 and are sufficient to completely describe the eye diagram, and hence, the transmission.

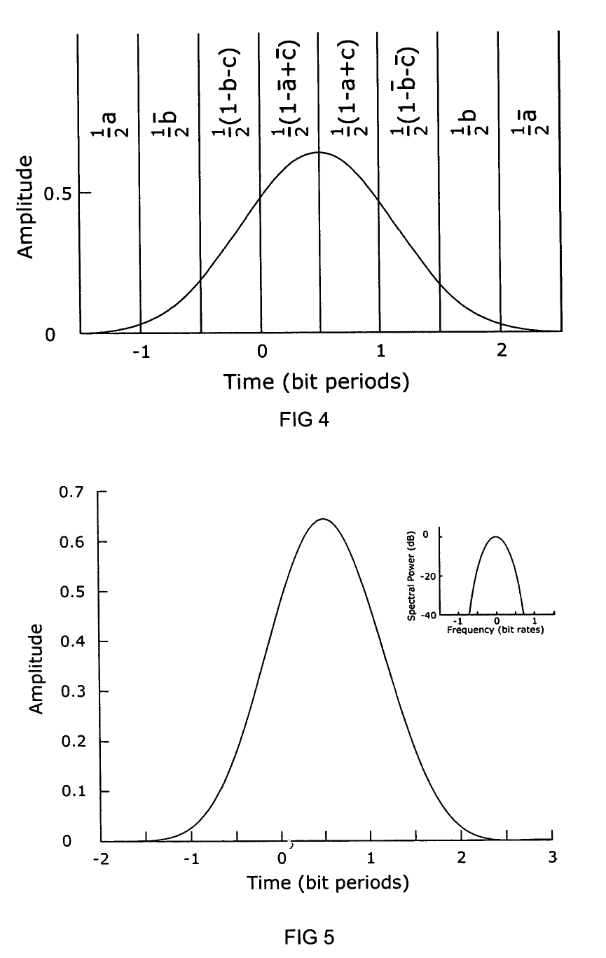

Any transmission having such an eye diagram can be expressed using the ASI FSM, the three functions, a, b and c, and direct detection. The corresponding 4P3P unit modulation pulse can be expressed, as illustrated in FIG. 4, in terms of these constituent functions. As shown, the 4P3P pulse spans four bit periods, establishes the eye diagram, and, together with the ASI FSM, defines a general class of line codes. Functions a, b, and c, and their time-reversed counterparts (indicated by over-bar) are each defined over one-half bit period, and together define the unit pulse. Optimizing transmission over this set of line codes produces signal sets having enhanced performance. In accordance with the principles of the invention, the optimized signals are produced by filtering the output of an electrical drive circuit.

The unit pulse will be continuous when

a(½)=b(½)

c(½)=0

2·b(0)=1−c(0) (7)

and will have continuous derivatives when

a′(½)=−b′(½)

c′(0)=0. (8)

The parameters for the eye diagram shown in FIG. 2 are

$$a ( t ) = {\frac{1 - α}{2} [ 1 - sin ( ( 1 - t ) \frac{π}{2} ) ]}^{η} , b ( t ) = {\frac{1 - α}{2} [ 1 - sin ( t \frac{π}{2} ) ]}^{η} ,$$

and c(t)=α[cos(tπ)], with α=0.1628, ξ=1.1482 and η=1.0523. In constructing the 4P3P unit modulation pulse, the component signals, a, b and c, which are only defined for

$$0 \leq t \leq \frac{1}{2} ,$$

are translated into each half-bit period, according to the definition as shown in FIG. 4.

A sample unit pulse is shown in FIG. 5. There, the pulse bit period begins at time t=−0.5, with unit duration. The unit pulse is centered on the end of a bit period.

Optimizing over the 4P3P unit modulation pulses represents a robust method for optimizing transmission using chromatic dispersion tolerant line codes. As noted above, the resulting modulation unit pulses are obtained by filtering from the output pulses of the electrical drive circuit. Optimized performance in the presence of chromatic dispersion is thus realized in an implementation that may be more readily manufactured.

The techniques described above are applicable to optimization with respect to many different criteria. In each case, a figure of merit is calculated, based on some criterion of transmission performance. The three parameters of the 4P3P modulation are adjusted until an optimum is achieved. By establishing the figure of merit to represent significant performance aspects of the system of interest, line codes can be tailored to meet the specific needs of the system architect.

For application to transmission systems in which amplification is not required, the receive sensitivity can be determined, and the modulation optimized for performance at a given net chromatic dispersion. In systems where back-to-back eye shape is critical, measures of eye asymmetry can be incorporated into the optimization figure of merit, in order to simultaneously optimize chromatic dispersion, constrained by a minimum eye symmetry requirement.

As an example, an optically amplified system with significant net chromatic dispersion requirements is considered. The figure of merit of interest is the optical signal-to-noise ratio (“OSNR”) required to achieve a given threshold bit-error-rate (“BER”), anywhere within a window of net chromatic dispersion. The OSNR sensitivity is calculated, presuming negligible thermal noise in the receiver. Additionally, the noise performance is modeled presuming that signal-spontaneous beat noise dominates the error statistics. The system will be considered to allow linear optical signal propagation, in a single-channel context.

Consideration is given to a maximum dispersion, Dₘₐₓ, and determination of all sets of 3-component parameters, p_{Δ}={a_{Δ},b_{Δ},c_{Δ}}, such that the ratio of OSNR sensitivities, measured in dB, between D=0 and D=Dₘₐₓ, is

10·log₁₀(S(p_{Δ},Dₘₐₓ,BER)/S(p_{Δ},0,BER))=Δ dB. (9)

The optimizing parameter, p(Δ,Dₘₐₓ,BER), is determined such that

$$S ( p ( Δ , {D}_{max} , BER ) , {D}_{max} , BER ) = {min}_{{p}_{Δ}} ( S ( {p}_{Δ} , {D}_{max} , BER ) ) ,$$

where p_{Δ} is defined according to Eq. (9). This method produces one optimized unit pulse, defined by pulse parameters p(Δ,Dₘₐₓ,BER), for each set of values, {Δ,Dₘₐₓ,BER}.

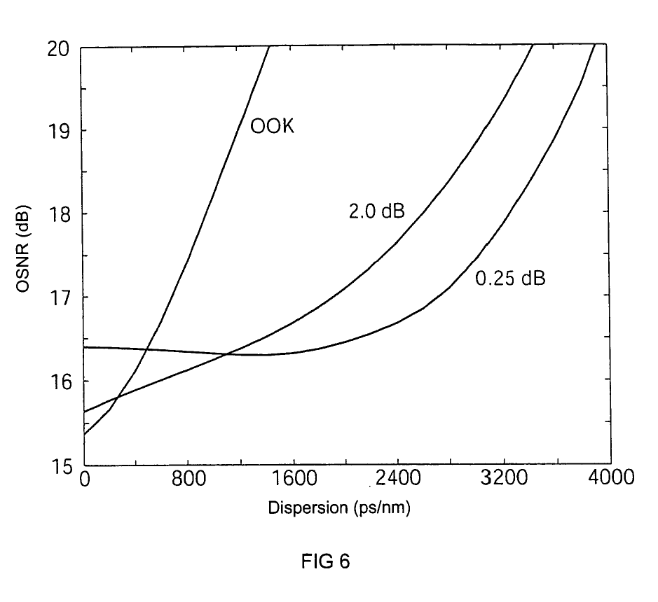

The optimized codes demonstrate the benefits of this technique, as shown in FIG. 6 for an exemplary 10 Gb/s transmission system. Standard OOK modulation produces large penalties in OSNR sensitivity, as dispersion increases. For a small, 0.25 dB, cost at D=0, the OSNR penalty can be reduced so that it is only 2.0 dB at D=2400 ps/nm. For a 1.0 dB cost at D=0, the OSNR penalty at D=2400 ps/nm can be reduced to 0.25 dB. These are optimized, with filters determined from the optimization procedure described above. The filters produce the best possible performance at D=2400 ps/nm, given the desired differential with respect to D=0.

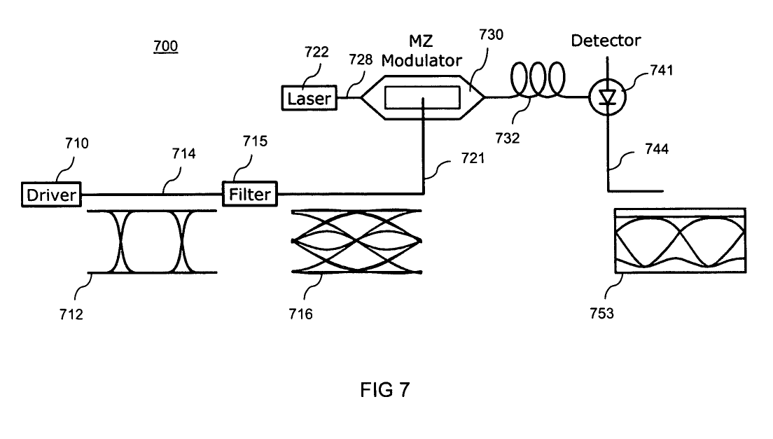

Turning now to FIG. 7, there is shown an illustrative arrangement which facilitates practice of the inventive filtered three-level transmitter. Electronic driver circuit 710 produces a binary signal output signal on line 714. A typical waveform output by the electronic driver circuit 710 is indicated by reference numeral 712. An optimized three-level filter 715 converts the received binary signal received on line 714 to a three-level signal. An illustrative waveform having three-levels produced by the optimized three-level filter 715 is shown in FIG. 3, and indicated by reference numeral 716. MZ modulator 730 is coupled to receive the three-level signal on line 721 and receive CW laser light on line 728, as shown. MZ modulator 730 applies the three-level signal to CW laser light from laser 722 to thereby produce dispersion tolerant transmission. MZ modulator 730 outputs the transmission into optical line 732 (which may include amplification) that is received by IM-DD detector 741. IM-DD detector produces a corresponding binary output signal on line 744. An illustrative output signal is indicated by reference numeral 753 in FIG. 3.

Other features of the invention are contained in the claims that follow.

What is claimed is:

1. A method for controlling a Mach-Zehnder modulator used in a transmission system, the method comprising the steps of:
filtering a binary electrical drive signal to produce a unit modulation pulse spanning four-bit-periods and describable by three parameters;
adjusting one or more of the three parameters of the unit modulation pulse to optimize a figure of merit associated with performance of the transmission system; and
generating, from the unit modulation pulse, a three-level electrical drive signal for input to the Mach-Zehnder modulator.

2. The method of claim 1 where the three parameters are each defined over a half-bit period and together are sufficient to describe a line-coded transmission eye diagram.

3. The method of claim 1 where the three parameters are further defined as a, b, and c, respectively and describable by
$$a ( t ) = {\frac{1 - α}{2} [ 1 - sin ( ( 1 - t ) \frac{π}{2} ) ]}^{η} , b ( t ) = {\frac{1 - α}{2} [ 1 - sin ( t \frac{π}{2} ) ]}^{η} ,$$
and
c(t)=α[cos(tπ)]^{ξ}
for some α, η, and ξ.

4. The method of claim 1 where the step of adjusting is performed so that performance of the transmission system is enhanced at set levels of net chromatic dispersion.

5. A transmitter comprising:
an input for receiving a binary electrical drive signal;
a filter for filtering the received binary electrical drive signal to produce a transmission having a unit modulation pulse with substantially three levels, which unit pulse produces optimized transmission performance over a set of values of net chromatic dispersion; and
a modulator coupled to the filter to receive a filtered three-level electrical drive signal.

6. The transmitter of claim 5, further including a controller coupled to the filter for selectively varying the unit modulation pulse to further enhance the transmission performance in accordance with optimization criteria

7. The transmitter of claim 5, where the optimization criteria include the minimization of dispersive impairments penalties in transmitter performance.
